(19) United States
(12) Patent Application Publication
(10) Pub. No.: US 2017/0018769 A1
(43) Pub. Date: Jan. 19, 2017

(54) BCC METAL HYDRIDE ALLOYS FOR ELECTROCHEMICAL APPLICATIONS

(71) Applicant: Ovonic Battery Company, Inc., Rochester Hills, MI (US)

(72) Inventors: Kwo-hsiung Young, Troy, MI (US); Taihei Ouchi, Oakland Township, MI (US); Baoquan Huang, Troy, MI (US); Michael A. Fetcenko, Rochester, MI (US)

(21) Appl. No.: 14/802,134

(22) Filed: Jul. 17, 2015

(51) Int. Cl. H01M 4/38; C22C 27/02; C22C 30/00

(52) U.S. Cl. CPC H01M 4/383; C22C 30/00; C22C 27/025

(57) ABSTRACT

BCC metal hydride alloys historically have limited electrochemical capabilities. Provided are a new examples of these alloys useful as electrode active materials. BCC metal hydride alloys provided include a disordered structure that is formed of a BCC primary phase and three or more electrochemically active secondary phases that are induced to create structural disorder in the system. The structurally disordered hydrogen storage alloys possess unexpectedly superior electrochemical characteristics relative to compositionally similar materials.

### STATEMENT OF GOVERNMENT SPONSORSHIP

This invention was made with government support under contract no. DE-AR0000386, awarded by Advanced Research Projects Agency—Energy—U.S. Department of Energy under the robust affordable next generation EV-storage (RANGE) program. The government has certain rights in the invention.

### FIELD OF THE INVENTION

This disclosure relates to alloy materials and methods for their fabrication. In particular, the disclosure relates to metal hydride alloy materials that are capable of absorbing and desorbing hydrogen. Activated metal hydride alloys with a body centered cubic (BCC) main phase structure are provided that have unique electrochemical properties including high capacity for use in electrochemical applications.

### BACKGROUND OF THE INVENTION

Certain metal hydride (MH) alloy materials are capable of absorbing and desorbing hydrogen. These materials can be used as hydrogen storage media, and/or as electrode materials for fuel cells and metal hydride batteries including nickel/metal hydride (Ni/MH) and metal hydride/air battery systems. However, due to limited gravimetric energy density (<110 Wh kg⁻¹), current Ni/MH batteries lose market share in portable electronic devices and the battery-powered electrical vehicle markets to the lighter Li-ion technology. As such, the next generation of Ni/MH batteries is geared toward improving two main targets: raising the energy density and lowering cost.

When an electrical potential is applied between the cathode and a MH anode in a MH cell, the negative electrode material (M) is charged by the electrochemical absorption of hydrogen to form a MH and the electrochemical evolution of a hydroxyl ion. Upon discharge, the stored hydrogen is released to form a water molecule and evolve an electron. The reactions that take place at the positive electrode of a Ni/MH cell are also reversible. Most Ni/MH cells use a nickel hydroxide positive electrode. The following charge and discharge reactions take place at a nickel hydroxide positive electrode.

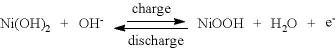

In a Ni/MH cell having a nickel hydroxide positive electrode and a hydrogen storage negative electrode, the electrodes are typically separated by a non-woven, felted, nylon or polypropylene separator. The electrolyte is usually an alkaline aqueous electrolyte, for example, 20 to 45 weight percent potassium hydroxide.

One particular group of MH materials having utility in Ni/MH battery systems is known as the ABₓ class of material with reference to the crystalline sites occupied by its member component elements. ABₓ type materials are disclosed, for example, in U.S. Pat. No. 5,536,591 and U.S. Pat. No. 6,210,498. Such materials may include, but are not limited to, modified LaNi₅ type (AB₅) as well as the Laves-phase based active materials (AB₂). These materials reversibly form hydrides in order to store hydrogen. Such materials utilize a generic Ti—Zr—Ni composition, where at least Ti, Zr, and Ni are present with at least one or more modifiers from the group of Cr, Mn, Co, V, and Al. The materials are multiphase materials, which may contain, but are not limited to, one or more Laves phase crystal structures and other non-Laves secondary phase. Current AB₅ alloys have ˜320 mAh g⁻¹ capacity and Laves-phase based AB₂ has a capacity up to 440 mAh g⁻¹ such that these are the most promising alloy alternatives with a good balance among high-rate dischargeability (HRD), cycle life, charge retention, activation, self discharge, and applicable temperature range.

Rare earth (RE) magnesium-based AB₃- or A₂B₇-types of MH alloys are promising candidates to replace the currently used AB₅ MH alloys as negative electrodes in Ni/MH batteries due in part to their higher capacities. While most of the RE-Mg—Ni MH alloys were based on La-only as the rare earth metal, some Nd-only A₂B₇ (AB₃) alloys have recently been reported. In these materials, the AB_{3.5} stoichiometry is considered to provide the best overall balance among storage capacity, activation, HRD, charge retention, and cycle stability. The pressure-concentration-temperature (PCT) isotherm of one Nd-only A₂B₇ alloy showed a very sharp take-off angle at the α-phase [K. Young, et al., Alloys Compd. 2010; 506: 831] which can maintain a relatively high voltage during a low state-of-charge condition. Compared to commercially available AB₅ MH alloys, a Nd-only A₂B₇ exhibited a higher positive electrode utilization rate and less resistance increase during a 60° C. storage, but also suffered higher capacity degradation during cycling [K. Young, et al., Int. J. Hydrogen Energy, 2012; 37:9882]. Another issue with known A₂B₇ alloys is that they suffer from inferior HRD relative to the prior AB₅ alloy systems due to less Ni-content in the alloy chemical make-up.

Other ABₓ materials include the Laves phase-related body centered cubic (BCC) materials that are a family of MH alloys with a two-phase microstructure including a BCC phase and a Laves phase historically present as C14 as an example. These materials are historically based on a theoretical electrochemical capacity of 1072 mAh g⁻¹ for an alloy with full BCC structure. To correct for the poor electrochemical properties of prior examples of such alloys, Laves phase with similar chemical make-up is added to the BCC material. These Laves phase-related BCC materials exhibit high density of the phase boundaries that allow the combination of higher hydrogen storage capacity of BCC and good hydrogen absorption kinetics and relatively high surface catalytic activity of the C14 phase. Many studies have been undertaken to optimize these materials. Young et al., Int. J. Hydrogen Energy, 2014; 39(36):21489-21499 describes a systematic study of these materials with a broad range of BCC/C14 ratio. These results reveal that while these materials have many desirable properties, the electrochemical discharge capacity produced by these materials does not exceed 175 mAh/g.

As such, there is a need for improved hydrogen storage materials. As will be explained herein below, the present invention addresses these needs by providing activated BCC metal hydride alloys that exhibit greatly improved electrochemical properties. These and other advantages of the invention will be apparent from the drawings, discussion, and description which follow.

### SUMMARY OF THE INVENTION

The following summary is provided to facilitate an understanding of some of the innovative features unique to the present alloys and is not intended to be a full description. A full appreciation of the various aspects of the alloys can be gained by taking the entire specification, claims, drawings, and abstract as a whole.

Provided are structurally disordered metal hydride alloy materials that exhibit excellent initial capacity and cycle life. The excellent electrochemical properties of the provided alloys are a result of the significant structural disorder in the system where a BCC primary phase is supplemented with three or more electrochemically active secondary phases throughout or partially throughout the alloy. As such, a structurally disordered hydrogen storage alloy is provided that is capable of reversibly charging and discharging hydrogen electrochemically, where the alloy includes: a primary phase and three or more electrochemically active secondary phases, where the primary phase has a crystal structure of BCC, and the secondary phases are induced to create structural disorder in the alloy. Unexpectedly, some aspects of the alloy have an electrochemical discharge capacity of 350 mAh/g or greater at a discharge rate of 100 mAh/g. Optionally, one or more of the electrochemically active secondary phases in the alloy is a C14, TiNi, or Ti₂Ni phase. Optionally, an electrochemically active secondary phase is a Ti₂Ni secondary phase. In aspects where at least one of the electrochemically active secondary phases is a Ti₂Ni secondary phase, the Ti₂Ni secondary phase is optionally present at a relative phase abundance of 2% by weight. Optionally, an alloy includes four electrochemically active phases. A primary phase in an alloy is a BCC phase, optionally present at a relative phase abundance of 50 weight percent or greater. In some aspects of any of the forgoing, an alloy has an elemental composition of Formula I:

Ti_{w}VₓCr_{y}M_{z} (I)

where w+x+y+z=1, 0.1≦w≦0.6, 0.1≦x≦0.6, 0.01≦y≦0.6, and M is selected from the group consisting of B, Al, Si, Sn and transition metals. In some aspects, an alloy has an electrochemical discharge capacity of 350 mAh/g or greater at a discharge rate of 100 mA/g. It is appreciated that any combination of the foregoing may represent an aspect or aspects of the alloy.

The alloys provided and their equivalents represent superior materials optionally for use in an anode of a cell or battery system.

### BRIEF DESCRIPTION OF THE DRAWINGS

FIG. 1A illustrates alloy phase distribution as observed in an SEM image of hydrogen storage alloy P17A following activation;

FIG. 1B illustrates alloy phase distribution as observed in an SEM image of hydrogen storage alloy P37A following activation; and

FIG. 2 illustrates the cycling stability of a structurally disordered hydrogen storage alloy (circles) in comparison to a traditional hydrogen storage alloy.

### DETAILED DESCRIPTION OF THE INVENTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Hydrogen storage alloys having BCC structures have been studied for some time to identify how to capitalize on the high theoretical capacity of as much as 1072 mAh/g owing to the very high (up to 4.0 wt percent) hydrogen storage capacity. Due to the strong metal-hydrogen bonding and low surface reaction activity of BCC metal hydride alloys, few electrochemical studies have been performed. Inoue and his coworker reported a TiV_{3.4}Ni_{0.6} alloy achieving 360 mAh/g at room temperature with a discharge rate of 50 mA/g [3]. Mori and Iba improved both the capacity and cycle stability by adding Y, lanthanoids, Pd, or Pt into a TiCrVNi BCC alloy and reached 462 mAh/g [4]. Yu and his coworker reported a Ti₄₀V₃₀Cr₁₅Mn₁₅ alloy with an initial capacity of 814 mAh/g measured with a rate at 10 mA/g at 80° C.; however, degradation was high due to surface cracking and V leaching into KOH electrolyte leaving TiOₓ on the surface blocking further electrochemical reaction [5]. Secondary phases, such as C14, C15, and B2, with a high grain boundary density were developed to improve the absorption kinetics [6], to facilitate formation due to its brittleness [7-9], and to increase the surface catalytic activity [10, 11]) by increasing the synergetic effect between the two phases. The density of phase boundaries also promotes the formation of coherent and catalytic interfaces between BCC and the secondary phases, improving hydrogen absorption [12]. In contrast to these prior attempts, the alloys provided herein represent a simple and elegant solution to these problems by providing BCC structured metal hydride alloy materials that exhibit excellent initial capacity. The provided alloys capitalize on significant structural disorder throughout the alloy material where the primary BCC phase is captured in a structurally discorded system with three or more electrochemically active secondary phases that contribute to the electrochemical performance of the alloy. The alloys provided have utility as an electrochemical material suitable for use in an anode of an electrochemical cell.

As used herein, the term “structural disorder” or “structurally disordered” is directed to an alloy in which the compositional, positional and translational relationships of atoms are not limited by crystalline symmetry in their freedom to interact. The disordered electrode materials, unlike the specific and rigid structure of crystalline materials, are ideally suited for manipulation since they are not constrained by the symmetry of single phase crystalline lattice or by stoichiometry. Structural disorder is atomic in nature and in the form of compositional or configurational disorder throughout the bulk of the alloy material or in numerous regions of the material. As such, structural disorder is may be found in numerous regions or throughout the entire material. The types of disordered structures are provided by multicomponent polycrystalline materials and/or lacking a long range compositional order (greater than 200 or 300 angstroms). In the present alloys, the disorder is found over a primary phase and three or more electrochemically active secondary phases that are structurally disordered throughout at least a portion of the overall material, optionally the entire alloy material.

As used herein, the term “electrochemically active” is intended to mean that the material functions in the absorption or desorption of proton accompanied by the electron in and out from the outside circuitry during electrochemical cycling.

Provided are structurally disordered hydrogen storage alloys capable of reversibly charging and discharging hydrogen electrochemically and having a primary phase and three or more electrochemically active secondary phases. The material includes a primary phase with a BCC structure that exhibits excellent initial capacity. The BCC phase is optionally of a phase abundance of 30% or greater, optionally 40% or greater, optionally 50% or greater, optionally 60% or greater, optionally 70% or greater, optionally 80% or greater by weight. A BCC phase is optionally in a phase abundance of 30% to 80% by weight, or any value or range therebetween. Unexpectedly superior function is achieved in alloys with a BCC primary phase of 50% to 60% weight percent when in the presence of three or more electrochemically active secondary phases. Phase abundance of the primary phase and secondary phases is optionally as measured by X-ray diffraction analysis.

A structurally disordered alloy as provided herein optionally illustrates excellent initial discharge capacity. In some aspects, a structurally disordered alloy presents a capacity at cycle 10 of 350 mA/g or greater when measured at a discharge rate of 100 mA/g. Optionally a structurally disordered alloy presents an initial capacity under the same conditions of 360 mA/g, 370 mA/g, 380 mA/g, 390 mA/g, 400 mA/g, 410 mA/g, 420 mA/g, or greater. In some aspects, a structurally disordered alloy presents a capacity at cycle 10 of 350 mA/g to 400 mA/g, or any value or range therebetween when measured at a discharge rate of 100 mA/g.

A structurally disordered alloy as provided herein optionally has excellent cycle life capable of maintaining a capacity of 300 mAh/g out to 30 or more cycles, optionally 40 or more cycles, optionally 50 or more cycles, optionally 60 or more cycles, optionally 70 or more cycles, optionally 80 or more cycles. In some aspects, a structurally disordered alloy as provided herein optionally has excellent cycle life capable of maintaining a capacity of 350 mAh/g out to 30 or more cycles, optionally 40 or more cycles, optionally 50 or more cycles, optionally 60 or more cycles.

A structurally disordered alloy includes three or more electrochemically active secondary phases. A secondary phase is optionally a C14 phase, TiNi phase, Ti₂Ni phase, or combinations thereof. The three or more secondary phases optionally include a C14 phase, TiNi phase, and a Ti₂Ni phase. The phase abundance of each of the secondary phases is below that of the primary phase in some aspects. Each of the secondary phases is optionally present at a phase abundance as measured by X-ray diffraction analysis of 1% to 49%, optionally 3% to 45%, optionally 4% to 40%, as measured by weight.

In some aspects, an electrochemically active secondary phase includes a C14 phase. A C14 phase is optionally in a phase abundance as measured by X-ray diffraction analysis of 1% to 13%, optionally 1% to 10%, optionally 1% to 8%, optionally 2% to 8%, optionally 2% to 6%, as measured by weight.

In some aspects, an electrochemically active secondary phase includes a TiNi phase. A TiNi phase is optionally in a phase abundance as measured by X-ray diffraction analysis of 1% to 40%, optionally 10% to 40%, optionally 20% to 40%, optionally 30% to 40%, optionally 30% to 35%, as measured by weight. Optionally, a TiNi phase is present at predominance among all electrochemically active secondary phases.

In some aspects, an electrochemically active secondary phase includes a Ti₂Ni phase. It was unexpectedly discovered that in an alloy with a BCC primary phase and three or more electrochemically active secondary phases, that the presence of a Ti₂Ni phase as an electrochemically active secondary phase correlated with a significant increase in discharge capacity and cycle life. A Ti₂Ni phase is optionally present in a phase abundance of 2% or greater as measured by X-ray diffraction analysis. A Ti₂Ni phase is optionally present in a phase abundance by weight of 3% or greater, optionally 4% or greater, optionally 5% or greater, optionally 6% or greater, optionally 7% or greater, optionally 8% or greater, optionally 9% or greater, optionally 10% or greater. In some aspects, a Ti₂Ni phase is optionally present in a phase abundance of 2% to 12%, optionally 10% to 11%, as measured by weight.

In some aspects, the three or more electrochemically active secondary phases include a C14 phase, a TiNi phase and a Ti₂Ni phase. The C14 phase, a TiNi phase and a Ti₂Ni phase are optionally each present at the relative phase abundances as described herein for each individually. Optionally, as measured by X-ray diffraction analysis, a C14 phase is present at a phase abundance of 1% to 49%, optionally 3% to 45%, optionally 4% to 40%, a TiNi phase is present at a phase abundance of 1% to 40%, optionally 10% to 40%, optionally 20% to 40%, optionally 30% to 40%, optionally 30% to 35%, and a Ti₂Ni phase is present at a phase abundance of 3% or greater, optionally 4% or greater, optionally 5% or greater, optionally 6% or greater, optionally 7% or greater, optionally 8% or greater, optionally 9% or greater, optionally 10% or greater, optionally with the TiNi phase as the predominant electrochemically active secondary phase and/or with a Ti₂Ni phase at 2% or greater, each as measured by weight.

In some aspects, a structurally disordered alloy includes a BCC primarily phase and 4 or more electrochemically active secondary phases. Optionally, three of the 4 or more electrochemically active secondary phases include a C14 phase, a TiNi phase and a Ti₂Ni phase, optionally at the relative phase abundances as provided herein. In some aspects, a structurally disorder alloy includes a BCC primarily phase and 5 or more electrochemically active secondary phases. Optionally, three of the 5 or more electrochemically active secondary phases include a C14 phase, a TiNi phase and a Ti₂Ni phase, optionally at the relative phase abundances as provided herein.

In some aspects, a structurally disorder alloy comprises the composition of Formula I.

Ti_{w}VₓCr_{y}M_{z} (I)

where w+x+y+z=1, 0.1≦w≦0.6, 0.1≦x≦0.6, 0.01≦y≦0.6 and M is selected from the group consisting of B, Al, Si, Sn, and one or more transition metals. The alloy is activated by particular processes to promote formation of a BCC phase primary phase in the resulting materials along with three or more electrochemically active secondary phases. The result is an activated metal hydride alloy with an electrochemical discharge capacity of 300 mAh/g or greater measured at a discharge rate of 100 mA/g at cycle 10, optionally an initial discharge capacity of 350 mAh/g or greater measured at a discharge rate of 100 mA/g.

In some aspects, an alloy of Formula I comprises a modifier effective to enlarge the unit cell. A modifier is optionally selected from the group consisting of Zr, Mo, Nb, or combinations thereof.

A structurally disordered hydrogen storage alloy may be manufactured by annealing an ingot under particular conditions such as temperature and annealing current. Annealing is used to tailor the type and amount of primary phase relative to secondary phase(s). An ingot is prepared by methods well recognized in the art such as by the combination of raw materials that are melted such as by high-frequency induction or arc melting. Processes of forming a structurally disordered alloy are provided whereby an ingot of elemental components, are annealed at an annealing temperature of 900° C. or greater for an annealing time to produce the structurally disordered alloy.

An annealing temperature used in a process is 900° C. or greater. Optionally, an annealing temperature is from 900° C. to 940° C. It has been found that an annealing temperature of from 900° C. to 940° C. for a significant annealing time will produce an alloy with optimum electrochemical properties. Optionally, an annealing temp is 900, 905, 910, 920, 930, 935, 940, 945, or 950° C. An annealing temperature is applied to an ingot for an annealing time. At an annealing temperature of 900° C. to 940° C., an annealing time is optionally from 3 hours to 15 hours, or any value or range therebetween. Optionally, an annealing time is from 4 hours to 10 hours. Optionally, an annealing time is from 8 hours to 12 hours. Optionally an annealing time is 12 hours or more. Optionally, an annealing time is 3, 4, 5, 6, 7, 8, 9, 10, 11, 12, 13, 14, or 15 hours.

The annealing power is optionally used to produce sufficient disorder in the alloy to produce the four or more electrochemically active phases with the desired electrochemical properties. During annealing such as by arc melting, the current must be sufficient to produce total alloying of the constituent elements and thereby create the resulting disorder in the system. For example, in some aspects, the current used in arc melting is in excess of 180 A when at a constant voltage of 18 V. Optionally, the current is at or in excess of 190 A, optionally 200 A. A current is optionally 200 A or greater at a constant voltage of 18 V, or other equivalent as defined by Ohm's Law.

The physical, structural, and electrochemical properties of the structurally disordered hydrogen storage alloy are promoted by increasing the amount of BCC phase structure to the material, or combinations thereof. As such, processes of activating (hydriding) the annealed alloy are used to promote the overall functional aspects of the alloys. The alloys are activated process includes subjecting the metal hydride alloy to an atmosphere including hydrogen at a hydrogenation pressure and simultaneously cooling the alloy to produce an activated metal hydride alloy having the desired capacity, optionally 350 mAh/g at cycle 10. Subjecting primarily BCC metal hydride alloy to hydrogen at elevated pressures, however, will increase the temperature of the material due to the exothermic nature of the hydride formation reaction. It was discovered that allowing the temperature of the alloy to increase in an uncontrolled manner is detrimental to the resulting electrochemical properties of the activated alloy. As such, the alloys are optionally hydrogenated by a process that includes an active cooling step. Temperature control is achieved by cooling the reaction vessel such as with a water jacketed system or bath, or by other methods known in the art. Optionally, the reaction temperature of the alloy does not exceed 300° C.

In some aspects, the temperature of the alloy is maintained during hydrogenation between room temperature and optionally 300° C., optionally 295° C., optionally 290° C., optionally 285° C., optionally 280° C., optionally 275° C., optionally 270° C., optionally 260° C., optionally 250° C., optionally 240° C., optionally 230° C., optionally 220° C., optionally 210° C., optionally 200° C., optionally 190° C., optionally 180° C., optionally 170° C., optionally 160° C., optionally 150° C., optionally 140° C., optionally 130° C., optionally 120° C., optionally 110° C., optionally 100° C., optionally 90° C., optionally 80° C., optionally 70° C., optionally 60° C., optionally 50° C., optionally 40° C., optionally 30° C. In some aspects, an alloy is maintained during hydrogenation to a temperature between room temperature and 300° C., or to any value or range therebetween.

Increasing hydrogen pressure relative to prior activation methods is useful to promote formation of increased amounts of BCC phase in the resulting activated hydrogen storage alloy. As such, in some aspects hydrogenating the annealed alloy is performed at a hydrogenation pressure of 1.4 MPa or greater, optionally 1.5 MPa or greater, optionally 1.8 MPa or greater, optionally 2 MPa or greater, optionally 3 MPa or greater, optionally 4 MPa or greater, optionally 5 MPa or greater, optionally 6 MPa or greater.

In some aspects, the annealed alloy is hydrogenated using both a hydrogenation pressure in excess of 1.4 MPa and controlling the temperature to 300° C. or less. As such, an alloy is optionally activating with a hydrogenation pressure of between 1.4 MPa to 6 MPa, or greater, with cooling to prevent the alloy from exceeding 300° C., optionally 295° C., optionally 290° C., optionally 285° C., optionally 280° C., optionally 275° C., optionally 270° C., optionally 260° C., optionally 250° C., optionally 240° C., optionally 230° C., optionally 220° C., optionally 210° C., optionally 200° C., optionally 190° C., optionally 180° C., optionally 170° C., optionally 160° C., optionally 150° C., optionally 140° C., optionally 130° C., optionally 120° C., optionally 110° C., optionally 100° C., optionally 90° C., optionally 80° C., optionally 70° C., optionally 60° C., optionally 50° C., optionally 40° C., optionally 30° C. At any one of the above temperature ranges the hydrogenation pressure is optionally 5 MPa or greater, optionally 4 MPa or greater, optionally from 6 MPa to optionally 1.4 MPa, optionally 1.5 MPa, optionally 1.6 MPa, optionally 1.7 MPa, optionally 1.8 MPa, optionally 1.9 MPa, optionally 2 MPa, optionally 2.1 MPa, optionally 2.2 MPa, optionally 2.3 MPa, optionally 2.4 MPa, optionally 2.5 MPa, optionally 2.6 MPa, optionally 2.7 MPa, optionally 2.8 MPa, optionally 2.9 MPa, optionally 3 MPa, optionally 3.1 MPa, optionally 3.2 MPa, optionally 3.3 MPa, optionally 3.4 MPa, optionally 3.5 MPa, optionally 3.6 MPa, optionally 3.7 MPa, optionally 3.8 MPa, optionally 3.9 MPa, optionally 4 MPa, optionally 4.1 MPa, optionally 4.2 MPa, optionally 4.3 MPa, optionally 4.4 MPa, optionally 4.5 MPa, optionally 4.6 MPa, optionally 4.7 MPa, optionally 4.8 MPa, optionally 4.9 MPa, optionally 5 MPa, optionally 5.1 MPa, optionally 5.2 MPa, optionally 5.3 MPa, optionally 5.4 MPa, optionally 5.5 MPa, optionally 5.6 MPa, optionally 5.7 MPa, optionally 5.8 MPa, optionally 5.9 MPa. In some aspects the hydrogenation pressure is 6 MPa or greater.

The resulting activated hydrogen storage alloy produced by the provided processes possesses the necessary structural disorder and capacities that nearly double and often more than double those of compositionally similar materials produced in traditional manners.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### EXPERIMENTAL

Two metal hydride alloys of the formulas were prepared with the same target formulas as depicted in Table 1.

| Ti | Zr | V | Cr | Mn | Co | Ni | Al |
|---|---|---|---|---|---|---|---|
| 15.6 | 2.1 | 44.0 | 11.2 | 6.9 | 1.4 | 18.5 | 0.3 |

The raw materials were purchased from Chuo Denki Kogyo. 12 grams of each raw material was arc melted under an argon atmosphere in a 2 kg capacity induction melting furnace using a MgO crucible, an alumina tundish, and a steel pancake-shape mold. Prior to formation, the residual oxygen concentration in the system was reduced by subjecting a piece of sacrificial titanium to several melt-cool cycles. While alloy P17A (control) was made with an arc melting maximum current of 180 amp and a constant voltage at 18 volts, alloy P37A (example) was made with a maximum current of 200 amp and a constant voltage at 18 volts. The higher power used in the arc melting of the exemplary P37A alloy ensures the total alloying of the constituent elements, especially Cr and V with very high melting temperatures. The improvement in the uniformity in the as-cast ingot facilitates the formation of electrochemical beneficial microstructure as in the case of P37A. Study ingots were then subjected to several re-melt cycles with turning over to ensure uniformity in chemical composition. The resulting 12 gram ingots were subjected to annealing conditions performed in argon under vacuum conditions of 1×10⁻⁷ torr as generated by a diffusion pump and a mechanical pump.

A single piece (about 2 grams) of the resulting 12 gram ingot with a newly cleaved surface was activated by a 2-h thermal cycle between 300° C. and room temperature at 5 MPa H₂ pressure.

### Phase Distribution and Composition

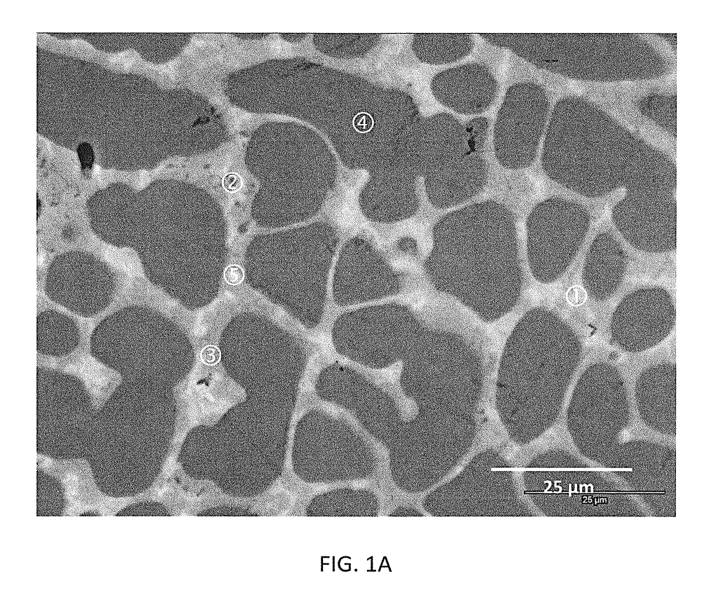

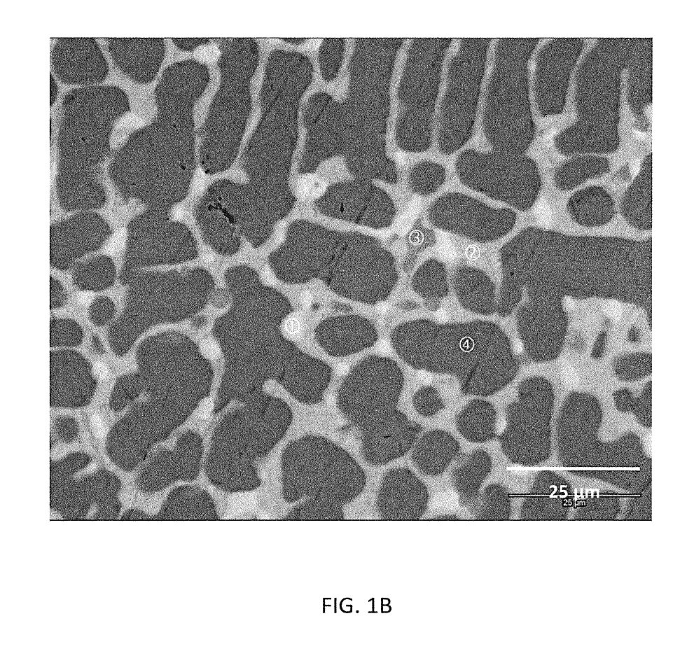

The alloy phase distribution and composition were examined using a JEOL-JSM6320F scanning electron microscope with energy dispersive spectroscopy (EDS) capability. Samples were mounted and polished on epoxy blocks, rinsed and dried before entering the SEM chamber. The back-scattering electron images (BEI) are presented in FIGS. 1A and 1B. Chemical compositions of a few selective spots, identified by a circled number in the SEM micrographs in FIGS. 1A and 1B, were studied by EDS, and the results are summarized in Tables 2 and 3.

TABLE 2
Summary of EDS results for P17A alloy (control).
All compositions are in atomic %.

| Numeral | Ti | Zr | V | Cr | Mn | Co | Ni | Al | Phase |
|---|---|---|---|---|---|---|---|---|---|
| 1 | 25.6 | 9.8 | 16.1 | 1.3 | 6.4 | 1.5 | 38.5 | 0.7 | AB₂ |
| 2 | 14.9 | 2.7 | 46.1 | 7 | 10.1 | 1.5 | 17.3 | 0.3 | TiNi/BCC |
| 3 | 37.4 | 3.3 | 7.8 | 0.9 | 3.6 | 3 | 43.4 | 0.6 | TiNi |
| 4 | 6.1 | 0.1 | 63.5 | 17.4 | 6.2 | 0.8 | 5.6 | 0.3 | BCC |

TABLE 3
Summary of EDS results for P37A alloy (example).
All compositions are in atomic %.

| Numeral | Ti | Zr | V | Cr | Mn | Co | Ni | Al | Phase |
|---|---|---|---|---|---|---|---|---|---|
| 1 | 22.8 | 10.1 | 19.9 | 4.4 | 5.7 | 2.1 | 34.2 | 0.7 | AB₂ |
| 2 | 37.6 | 4.6 | 5.7 | 0.8 | 2.4 | 2.8 | 45.3 | 0.8 | TiNi |
| 3 | 47.8 | 6.5 | 12.1 | 1.4 | 2.2 | 1.9 | 28 | 0.2 | Ti₂Ni |
| 4 | 4.6 | 0.1 | 64.7 | 16.9 | 8.2 | 0.7 | 4.5 | 0.1 | BCC |

The numeral 2 in the P17A alloy is not an independent phase but is merely a measured point that is demonstrated to be in between the TiNi phase and the BCC phase in the resulting material. In contrast, the P37A alloy has a grain boundary that is demonstrated to be a clear third electrochemically active secondary phase in the form of a Ti₂Ni phase. This illustrates four distinct and disordered phases in the same alloy which is believed to produce the unexpectedly superior electrochemical characteristics illustrated below.

The composition measured by the inductively coupled plasma (ICP) with P17A and P37A are Ti_{15.7}Zr_{1.8} V₄₃Cr_{11.1} Mn_{6.9}Co_{1.4}Ni_{18.7}Al_{1.3} and Ti_{15.6}Zr_{2.0}V_{43.9}Cr_{11.3}Mn_{6.4}Co_{1.4}Ni_{18.9}Al_{0.4}. P37A, made with a higher power in arc melting, shows a much lower Al-content, but should not account for the difference in microstructure as seen from SEM/EDS analysis.

Microstructure of the alloy was studied utilizing a Philips X'Pert Pro x-ray diffractometer. The overall phase composition of the P37A alloy was obtained from full pattern fitting of the XRD data using Jade 9 software. The resulting relative phase abundances are illustrated in Table 3.

TABLE 3
Overall phase abundance.

| | BCC | C14 | TiNi | Ti₂Ni |
|---|---|---|---|---|
| P17A | 52.80% | 13.20% | 34.00% | 0.00% |
| P37A | 53.60% | 4.50% | 31.70% | 10.20% |

The results illustrate that the P37A alloy is primarily a BCC structure with three additional electrochemically active secondary phases including an unexpected Ti₂Ni phase. The additional structural disorder is provided by the presence of the third electrochemically active secondary phase (Ti₂Ni) that is not observed in the more ordered P17A alloy.

### Electrochemical Characterization

The discharge capacity of each alloy was measured in a flooded-cell configuration against a partially pre-charged Ni(OH)₂ positive electrode. Electrodes were made with powder after activation. No alkaline pretreatment was applied before the half-cell measurement. Each sample electrode was charged at a constant current density of 100 mA/g for 6 h, and then discharged at 100 mA/g followed by three pulls at 50 mA/g, 8 mA/g, and 4 mA/g. The resulting capacities at each discharge are illustrated in Table 4.

TABLE 4
Electrochemical results.

| Rate | 100 mA/g | 50 mA/g | 8 mA/g | 4 mA/g | C100/C4 |
|---|---|---|---|---|---|
| P17A | 364 | 391 | 400 | 413 | 88% |
| P37A | 400 | 412 | 420 | 433 | 92% |

The results indicate that the presence of the additional phase in the P37A alloy produces a higher initial capacity as well as a significantly higher high rate dischargability (HRD) defined as the ratio of discharge capacity measured at 50 mA/g to that measured at 4 mA/g measured at the stabilized 4^{th} cycle. Thus, the presence of the additional third secondary phase (Ti₂Ni) phase significantly improves electrochemical performance.

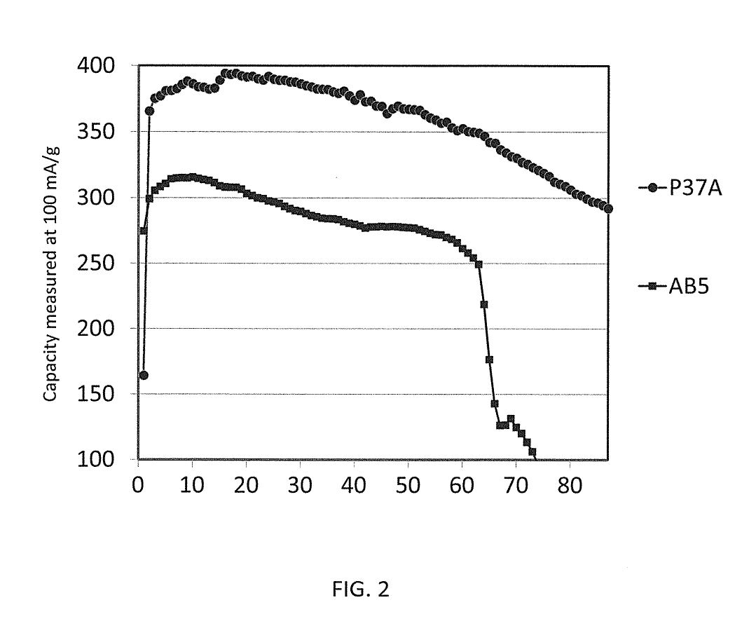

Also, unexpectedly, the presence of structural disorder in the P37A alloy significantly improves cycle stability. The above half cells were cycled at 100 mA/g charge for 4.5 hours followed by discharge to 0.9V. The cells were compared to identical cells using a traditional mischmetal/NiCoMnAl AB₅ alloy commercially available from Eutectix, Troy, Mich. The resulting cycle stability is illustrated in FIG. 2. While the traditional ordered alloy precipitously loses capacity significantly following 50 cycles, the disordered P37A alloy continues to cycle with a capacity in excess of 300 mA/g out to 80 cycles and does not produce a similar rate of cycle life loss out to 85 cycles, after which measurements were ceased.

These results clearly indicate that the presence of disorder in a BCC alloy due to the presence of at least 3 electrochemically active secondary phases significantly improves the HRD and cycle stability of anodes constructed using this alloy material.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. A structurally disordered hydrogen storage alloy capable of reversibly charging and discharging hydrogen electrochemically, said alloy comprising:
a primary phase and three or more electrochemically active secondary phases, said primary phase having a crystal structure of BCC, said secondary phases creating structural disorder in said alloy.

2. The alloy of claim 1 wherein said wherein said alloy has an electrochemical discharge capacity of 350 milliAmperehours per gram or greater at a discharge rate of 100 milliAmperehours per gram.

3. The alloy of claim 1 wherein one or more of said secondary phases is a C14, TiNi, or Ti₂Ni phase.

4. The alloy of claim 1 wherein one of said secondary phases is an electrochemically active Ti₂Ni secondary phase.

5. The alloy of claim 4 wherein said Ti₂Ni secondary phase is present at 2 weight percent or greater relative phase abundance.

6. The alloy of claim 1 comprising four electrochemically active phases.

7. The alloy of claim 6 comprising an electrochemically active Ti₂Ni secondary phase.

8. The alloy of claim 1 comprising greater than 50 weight percent BCC phase.

9. The alloy of claim 1 with an elemental composition of Formula I:
Ti_{w}VₓCr_{y}M_{z} (I)
where w+x+y+z=1, 0.1≦w≦0.6, 0.1≦x≦0.6, 0.01≦y≦0.6, and M is selected from the group consisting of B, Al, Si, Sn and transition metals.

10. The alloy of claim 9 having an electrochemical discharge capacity of 350 milliAmperehours per gram or greater at a discharge rate of 100 milliAmperehours per gram.

11. A structurally disordered hydrogen storage alloy capable of reversibly charging and discharging hydrogen electrochemically, said alloy comprising:
a primary phase having a crystal structure of BCC present at a phase abundance of 50 weight percent or greater; and
three or more electrochemically active secondary phases creating structural disorder in said alloy;
said alloy having an electrochemical discharge capacity of 350 mAh/g or greater at a discharge rate of 100 mA/g.

12. The alloy of claim 11 having an electrochemical discharge capacity of 400 mAh/g or greater at a discharge rate of 100 mA/g.

13. The alloy of claim 11 wherein one or more of said secondary phases is a C14, TiNi, or Ti₂Ni phase.

14. The alloy of claim 11 wherein one of said secondary phases is a Ti₂Ni phase.

15. The alloy of claim 14 wherein said Ti₂Ni secondary phase is present at 2 weight percent or greater relative phase abundance.

16. The alloy of claim 11 with an elemental composition of Formula I:
Ti_{w}VₓCr_{y}M_{z} (I)
where w+x+y+z=1, 0.1≦w≦0.6, 0.1≦x≦0.6, 0.01≦y≦0.6, and M is selected from the group consisting of B, Al, Si, Sn and transition metals.
